(19) United States
(12) Patent Application Publication
(10) Pub. No.: US 2008/0233358 A1
(43) Pub. Date: Sep. 25, 2008

(54) UNIVERSAL BARRIER SYSTEM

(76) Inventor: JUAN GARCIA, Tempe, AZ (US)

Correspondence Address: JENNINGS, STROUSS & SALMON, P.L.C., 201 E. WASHINGTON ST., 11TH FLOOR, PHOENIX, AZ, 85004, US

(21) Appl. No.: 12/039,483

(22) Filed: Feb. 28, 2008

Related U.S. Application Data
(60) Provisional application No. 60/895,932, filed on Mar. 20, 2007.

(51) Int. Cl. B32B 3/02; B29C 65/00

(52) U.S. Cl. 428/189; 428/192; 156/60

(57) ABSTRACT

A universal barrier system includes universal barrier components that may be assembled together to shield floors and walls from moisture and provide a thermal break in an operational area of the universal barrier component. A lap zone of the universal barrier component may allow universal barrier components to be assembled and installed to protect floors, walls, ceilings, footings and the like from moisture and heat gain or loss by minimizing the need for tapes and other joining methods. The universal barrier system may also act as a sound deadening material. The operational area and lap zone of the universal barrier component may be disposed on a vapor block layer to provide some rigidity. The operational area of the universal barrier component may include a thermal break disposed upon the vapor block layer. The thermal break may include an outer protective layer. In addition, universal barrier tape and universal barrier edging may be provided to couple adjoining universal barrier components.

### CROSS-REFERENCE TO RELATED APPLICATION

This application claims the benefit of U.S. Provisional Patent Application Entitled: UNIVERSAL BARRIER SYSTEM, No. 60/895,932 filed Mar. 20, 2007, the contents of which are hereby incorporated by reference.

### TECHNICAL FIELD

This description relates generally to building construction and more specifically to thermal breaks and moisture or vapor barriers.

### BACKGROUND

In building construction, a great amount of effort is typically expended in shielding the building interior and its inhabitants from the elements. In particular, a building typically shields its occupants from moisture, heat and cold. In addition, moisture can be harmful to the building structure itself. The roof, walls and floor of a building typically include a number of components provided to resist the elements. For example, a wall may include exterior shingles, sheeting, insulation, a frame and interior plaster. A floor may include a foundation footing, a concrete slab and a reinforcing mesh.

Existing structural components have traditionally provided adequate shielding when they were developed. However, as times have changed, energy costs have risen, which tend to make improved insulation more important. Also, as time goes on, builders typically seek to improve the quality and cost effectiveness of their construction methods. An area that could be improved, is providing cost effective moisture and vapor barriers that may tend to more effectively protect a building and its occupants.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a universal barrier system that tends to reduce the vapor and moisture intrusion into a structure. The universal barrier system may also provide a thermal break for improved insulation. The universal barrier system includes universal barrier components that may be assembled together to shield floors and walls from moisture and provide a thermal break in an operational area of the universal barrier component. A lap zone of the universal barrier component may allow universal barrier components to be assembled and installed to protect walls, floors, footings and the like from moisture and from heat loss. The operational area and lap zone of the universal barrier component may be disposed on a vapor block layer to provide some rigidity. The operational area of the universal barrier component may include a thermal break disposed upon the vapor block layer. The thermal break may include an outer protective layer. The universal barrier components may be disposed upon a roll during manufacturing, for easy transport and installation. In addition, tape may be provided to couple adjoining universal barrier components.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a plan view of a universal barrier component.

FIG. 2 is a profile view of the universal barrier component of FIG. 1.

FIG. 3 is a flow diagram showing a method of producing a thermal barrier component.

Like reference numerals are used to designate like parts in the accompanying drawings.

### DETAILED DESCRIPTION

The detailed description provided below in connection with the appended drawings, is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a vapor or moisture barrier system that may include a thermal break. Although the present examples are described and illustrated herein as being implemented in a building construction system, the system described is provided as an example and not a limitation. As those skilled in the art will appreciate, the present examples are suitable for application in a variety of different types of thermal and moisture barrier systems.

As an overview, the present example provides a universal barrier system that tends to reduce the vapor and moisture intrusion into a structure. The universal barrier system may also provide a thermal break for improved insulation. The universal barrier system may be disposed under a floor, or slab, and may also be assembled to insulate building footings. In walls, the universal barrier system may be assembled to limit moisture intrusion and provide insulation.

The universal barrier system includes universal barrier components that may be assembled together to shield floors and walls from moisture and provide a thermal break in an operational area of the universal barrier component. The universal barrier system may also act as a sound deadening material. A lap zone of the universal barrier component may allow universal barrier components to be assembled and installed to protect walls, floors, footings and the like from moisture, and from heat loss by minimizing the need for tapes and other joining methods. The operational area and lap zone of the universal barrier component may be disposed on a vapor block layer to provide some rigidity. The operational area of the universal barrier component may include a thermal break disposed upon the vapor block layer. The thermal break may include an outer protective layer. In addition, tape may be provided to couple adjoining universal barrier components.

The universal barrier components may be disposed upon a roll during manufacturing for easy transport and installation. Disposition and lamination may be advantageously accomplished simultaneously by a hybrid process of disposing a thermal break between the outer protective layer and vapor block layer. A typical vapor block layer may be provided by the exemplary VaporBlock™ material produced by Raven Industries of Sioux Falls, S. Dak. These concepts will be described in detail in the following paragraphs.

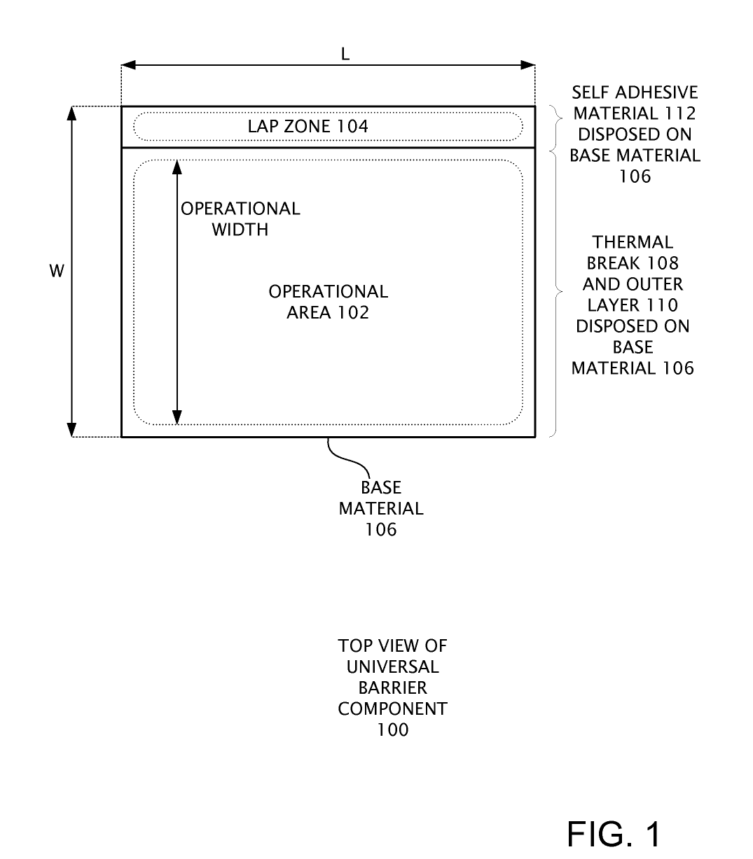

FIG. 1 is a plan view of a universal barrier component 100. The universal barrier component 100 may be a part of a universal barrier system that may include other thermal breaking components and or moisture barriers and vapor barriers. A typical universal barrier system may include the universal barrier component, insulating edging, and seaming tapes applied as needed in a given application, such as the construction of a building.

In particular, a universal barrier system for a floor may include multiple universal barrier components 100, coupled together to provide a thermal break and/or a moisture barrier under cement or other flooring materials. Further, universal barrier systems may include the universal barrier component 100 coupled to insulated footings and the like. Such a flooring system utilizing universal barrier components 100 may also extend to, and be coupled to, building walls that may or may not include the universal barrier components 100, and in a similar manner to roof components to form a building envelope providing thermal breaks and a moisture vapor barrier.

Universal barrier component 100 includes an operational area 102 and a lap zone 104. A typical overall width for a universal barrier component 100 is 54 inches, with a six inch wide lap zone 104 for overlap and a 48 inch wide operational area 102. In alternative examples, other widths of lap zone and operational area may be utilized. The universal barrier component 100 may be fabricated in any suitable length (“L”). The universal barrier component 100 is somewhat flexible and easy to work with. Also, the universal barrier system component 100 may be supplied in convenient lengths on a roll or alternatively in sheets cut to a given length. The operational area 102 and lap zone 104 of the universal barrier component 100 are typically disposed on a common base material 106.

The operational area 102 typically includes a vapor blocking base material 106, a thermal break 108, and a facing material 110 over the thermal break. The operational area 102 typically includes a thermal break 108 disposed on the base material 106. The operational area may also include an outer layer of facing material 110 disposed over the thermal break 108. The outer layer is typically a lighter weight material suitable for protecting the material making up the thermal break 108.

The lap zone 104 may include a self adhesive 112 disposed on the base material 106, for coupling the universal barrier component 100 to the adjoining operational area of an adjoining universal barrier component of a plurality of universal barrier components. The adhesive may be any conventional type suitable for use in the disclosed configuration. The adhesive may be protected by a non-sticking backing material that may be peeled away to couple the universal barrier component to an adjoining universal barrier component, universal barrier insulated edging, or other structural component.

In addition, universal barrier tape may be used to join universal barrier component 100 to other universal barrier components. Seaming tapes may be up to 12 inches wide and may be made of a “VaporBlock 10”™ material and a conventional adhesive. The seaming tapes typically provide 6 inches of lap as specified in ACI 302-1.

Insulated universal barrier edgings of the same insulting materials as in the thermal break, may be provided in typical widths of 12 to 14 inches to join universal barrier components. The insulated edgings typically provide insulating materials from 6 to 8 inches wide and have a lap zone typically 6 inches wide, covered with the previously described adhesive. The configuration is similar to that of the previously described universal barrier component 100, but with substantially narrower widths of operational areas.

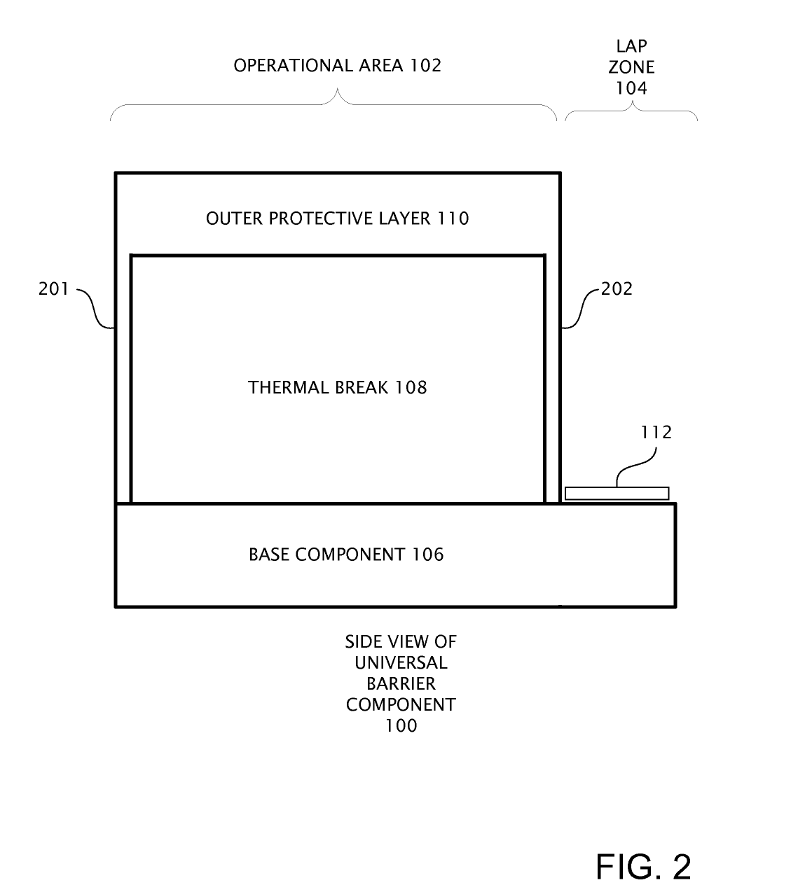

FIG. 2 is a profile view of the universal barrier component 100 of FIG. 1. The profile in the operational area 102 and the lap zone 104 are shown. The somewhat rigid vapor block layer forms a base component or base material 106 of the universal barrier component 100, which is a common base material 106 for both the lap zone 104 and operational areas 102. The rigid vapor block layer 106 may be made of a polyethylene film made of virgin resin of a high tinsel strength typically exceeding ASTM E-1745 class A, B and C requirements or its equivalent.

An exemplary base material 106 would be the polyethylene film manufactured by Raven Industries of Sioux Falls, S. Dak. and sold under the trade name VaporBlock™ 10 which is 10 mil thickness. A suitable tinsel strength for this material would be as defined in ASTME E-154 Section 9 and having a strength of 52 pounds per inches for new material and 55 pounds per inch after soaking. Puncture resistance would be as defined ASTM D-1709 Method B and would be 2600 grams. A typical use of that temperature range would be −70° F. to 180° F., and a typical new material permanence for a vapor block layer would be 0.036 Perms. In alternative examples, different thicknesses of the rigid vapor block layer 106 may be used, for example, 6 and 15 mils.

The rigid vapor block layer 106 typically impedes the transmission of water vapor from traveling upward through a concrete slab-on-grade or through a concrete wall. Installation of the rigid vapor block layer 106 should be such that it is not punctured to preserve its properties. Thus, adhesive joining as previously described may be advantageous.

Thermal break 108 typically includes an insulating material such as long chain polymers disposed over the base material 106 in the operational area 102. Typical long chain polymers would include foams and silicones, to improve the thermal performance of the universal barrier in various configurations. In particular, long chain polymers that are disposed on the base layer by a hybridized process of the two processes of extrusion and blowing may produce a thermal break that is easily disposed and flexible.

The outer protective layer 110 typically includes a facing material such as aluminum foil (or its equivalent) or a polyethylene film (or its equivalent). The aluminum foil would typically include high purity aluminum for improved thermal conductivity and/or reflectivity. The outer protective layer protects the material making up the thermal break from moisture and abrasion. The use of high purity aluminum typically improves the overall thermal performance of the thermal breaking properties of the universal barrier component for certain applications. The outer protective layer 110 may also be sealed against the base component 106 around the edges of the operational area 201 and 202 to provide additional protection to the thermal break material 108 that it is covering.

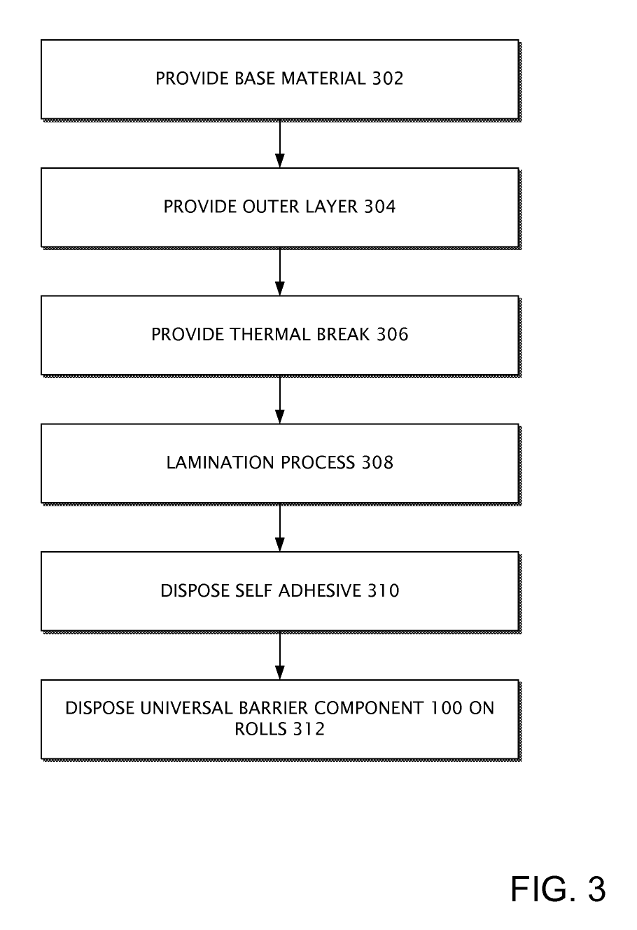

FIG. 3 is a flow diagram showing a method of producing a thermal barrier component. Universal barrier component is typically constructed on a laminating machine that assembles the 3 typical components (110, 108 and 106 of FIG. 2) previously described and disposes them on a roll. The adhesive (112 of FIG. 1) in the operational area may be disposed on the base material in this process or optionally in a second stage of processing.

At block 302 a base material is provided to the assembly machine. At block 304 an outer layer is provided to the assembly machine, and, at block 306 thermal break is provided to the assembly machine. At block 308, the process disposes the thermal break on the base material and also disposes an outer layer on top of the thermal break. In the lamination process 308, the outer layer is typically bonded by conventional methods to the base material at the edges of the operational area. Thus, the thermal break is sealed against moisture and dirt and is disposed against a firm backing material provided by the base material. Next, a layer of self-adhesive is disposed at block 310 along the lap zone of the base material. And finally, at block 312 the universal barrier component is disposed on rolls for shipment and use.

The lamination process for disposing the thermal break on the base material may utilize a standard spray or roller lamination process. In one example, a hybrid process of continuous molding may be utilized to dispose the insulation on the base layer. The process is a hybrid of conventional extrusion and blowing processes that tends to produce a flexible thermal break layer.

The universal barrier components tapes and edgings may be configured in a universal barrier system. The universal barrier system may be advantageously applied to a number of applications and configurations as described below.

A vapor barrier (or equivalently a vapor retarder) may prevent vapors, gases and moisture from entering a structure. Under slab vapor barriers such as the universal barrier system may be used on grade construction beneath conditioned space or on grade construction covered with a moisture sensitive flooring. In a building without a moisture protection system, the majority of the moisture within the building may originate from the building sites' ground water. Ground water may enter a building through a slab on grade, or below grade walls, via hydrostatic pressure, capillary action or vapor migration. Moisture infiltration through a slab on grade or walls below grade, may cause indoor air quality issues due to the proliferation of mold, mildew and fungus. It may also cause damage to the slab and increased building heating costs because of the increased thermal conductivity of a moist slab. And finally, excess moisture may cause flooring system failures. Installation of a universal barrier system may help to remedy these problems.

Preventing moisture infiltration with a universal barrier system may be important in preventing flooring failures. In flooring problems, failure can be evidenced by adhesive failure, warping, discoloration, deterioration and rust stains, and the like. For example, carpeted floors can wrinkle, wood floors may buckle, and painted floors, such as epoxy coated floors, may bubble. Hydrostatic pressure may be relieved by proper site drainage or by providing a water proofing barrier, such as the universal barrier system. Capillary action may be minimized by capillary break layer, or by installing a water proof barrier. And finally, vapor pressure may be reduced by installing a vapor barrier. The universal barrier system may function as a capillary break layer, a waterproof barrier and a vapor barrier. Not all materials that are water proofed are vapor proofed, however, all materials that are vapor proofed are water proofed. An example is fabric having a mechanically expanded layer of Teflon which allows water vapor in the form of perspiration to evaporate, but prevents water from coming through the fabric. There are a number of standards that deal with moisture and vapor barriers.

There are a number of industry codes and standards regarding vapor and moisture barriers. The American Society for Testing Materials (“ASTM”) has issued ASTME 1993-98 Bituminous Vapor Barriers, ASTME 1745-97 Plastic Vapor Barriers and ASTME 1643-98 Standard Practice for Vapor Barriers. In addition, the American Concrete Institute (“ACI”) has issued standard ACI 302-1 R-96. In particular the universal barrier system typically exceeds the Architectural and Building Codes for Vapor Barriers, as well as meeting or exceeding the ACI 302-1 vapor barrier specification for 2006 or its equivalent.

Under slab vapor barrier materials may include low density polyethylene (LDPE) membranes, composite LDPE and asphalt coated craft paper membrane, state of the art LDPE membranes (including polyolefin), cross laminated LDPE membranes, high density polyethylene (HDTE) membranes, fiber reinforced composite LDPE membranes, and multi-ply bituminous membranes. These materials have typically been supplied as a single material disposed underneath a slab. Utilization of the universal barrier system typically outperforms these materials.

When used as a floor, concrete keeps out most liquid water. However, concrete is porous, therefore, some moisture may wick up throughout slab and transpire into the air. To mitigate this, a thick cross laminated, high density polyethylene vapor barrier may be used under a concrete slab. High density polyethylene vapor barriers are typically installed on top of a layer of stones that promote drainage, with the high density polyethylene vapor barrier being in close contact with the underside of the concrete.

Building footings are in general,not insulated. Insulated footings can provide a thermal break to reduce condensation, or mold growth inside a building. Insulating the footing tends to keep the concrete on the inside of the structure at the same temperature as the air inside, thus, preventing condensation. Thus, disposing the universal barrier system on a footing may tend to improve the thermal performance of a footing. In addition, the universal barrier system may be coupled to a universal barrier system disposed underneath a floor or slab to form a continuous barrier.

Structural components such as a window lintel, the edge of a concrete floor slab, or a wood stud in an exterior frame wall can act as thermal bridges conducting heat flow around insulation. A thermal break is an insulating material intended to prevent structural components (such as concrete floors, and studs) from acting as thermal bridges. A thermal break typically provides a layer of insulation that tends to resist heat flow through a thermal bridge. To provide a thermal break, walls are typically assembled from the inside out using drywall, studs, insulation in the cavities, Styrofoam, SOB, siding and the like. Thermal breaks may be spray on insulation which is susceptible to damage by the sun and may allow the intrusion of termites into the structure. The universal barrier system advantageously provides a thermal break in addition to its moisture resistance to reduce thermal bridging.

A universal barrier system may be part of a building envelope. A building envelope can include a universal barrier system to limit water infiltration into unwanted areas and allow drainage and drying of wetted building materials. A typical moisture barrier system can include roof coverings, underlayment, overhangs, gutters, valleys, flashings, house wrap (or felt) and the universal barrier system. Many of these components may utilize a universal barrier system. A universal barrier system tends to resist the passage of both air and moisture through floors, walls and ceilings.

To work properly, the universal barrier system should be continuously disposed. There should be no tears or gaps near electrical receptacles, windows and the meetings of walls, ceilings and floors. The operational area having a self-adhesive edging promotes a continuous universal barrier system by allowing adjoining universal barrier components to couple to each other. Also, tapes provide a way to seal edges not having a convenient lap zone.

1. A universal barrier system for building construction comprising:
a universal barrier tape;
a plurality of universal barrier components coupled together by the universal barrier tape; and
a universal barrier edging coupled to at least on of the plurality of universal barrier components.

2. The universal barrier system for building construction of claim 1, in which the universal barrier component further comprises:
an operation al area; and
a lap zone disposed along the edge of the operational area.

3. The universal barrier system for building construction of claim 2, in which the lap zone includes an adhesive.

4. The universal barrier system for building construction of claim 2, in which the operational area includes a thermal break.

5. The universal barrier system for building construction of claim 4, in which the thermal break is a long chain polymer.

6. The universal barrier system for building construction of claim 4, in which the thermal break is a silicon insulating material.

7. The universal barrier system for building construction of claim 2, in which the operational area includes an outer protective layer.

6. The universal barrier system for building construction of claim 7, in which the outer protective layer is a polyethylene film.

7. The universal barrier system for building construction of claim 7, in which the outer protective layer is high purity aluminum foil.

8. A universal barrier component produced by a process comprising:
laminating a thermal break to a base material; and
laminating an outer layer to a thermal break.

9. The universal barrier component produced by a process of claim 8 further comprising sealing the outer layer to the base material around a plurality of edges of an operational area.

10. The universal barrier component produced by a process of claim 8 further comprising disposing an adhesive on a lap zone.

11. The universal barrier component produced by a process of claim 8 in which the laminating is performed by a hybridized process of an extruding process and a laminating process.

12. The universal barrier component produced by a process of claim 8 further comprising rolling the universal barrier component onto a roll.

13. The universal barrier component produced by a process of claim 8 in which the base material is polyethylene film,

14. The universal barrier component produced by a process of claim 13 in which the polyethylene film exceeds the requirements of ASTM E-1745 Class A, B and C.

15. The universal barrier component produced by a process of claim 8 in which the outer layer is polyethylene film.

16. A universal barrier system comprising:
a plurality of universal barrier components having a operational area and a lap zone; and
an insulated universal barrier edging coupled to at least one of the plurality of universal barrier components.

17. The universal barrier system of claim 16 further comprising a universal barrier tape coupled to at least one of the plurality of universal barrier components.

18. The universal barrier system of claim 16 in which each of the plurality of universal barrier components includes a base component common to the operational area and the lap zone.

19. The universal barrier system of claim 18 in which the operational area includes a thermal break disposed upon the base component and an outer protective layer disposed upon the thermal break and coupled to the base component at an edge of the operational area.

20. The universal barrier system of claim 18 in which the lap zone includes a self adhesive material disposed upon the base component common to the lap zone.

21. The universal barrier system of claim 18 in which one of the plurality of universal barrier components is a component of an underlayment.

22. The universal barrier system of claim 18 in which one of the plurality of universal barrier components is a component of a house wrap.
